(19) United States
(12) Patent Application Publication
(10) Pub. No.: US 2007/0171030 A1
(43) Pub. Date: Jul. 26, 2007

(54) Detecting apparatus, abnormality monitoring system

(75) Inventor: Hideyuki Kobayashi, Kyoto (JP)

Correspondence Address: FOLEY AND LARDNER LLP;SUITE 500, 3000 K STREET NW, WASHINGTON, DC, 20007, US

(73) Assignee: OMRON CORPORATION, KYOTO-SHI KYOTO JAPAN (JP)

(21) Appl. No.: 11/587,850

(22) PCT Filed: Aug. 10, 2005
(86) PCT No.: PCT/JP05/14645

§ 371 Date: Oct. 27, 2006

(30) Foreign Application Priority Data
Aug. 9, 2004 (JP) 2004-261369

(51) Int. Cl. B60R 25/10

(52) U.S. Cl. 340/426.1

(57) ABSTRACT

A detecting apparatus (200) of the present invention detects an abnormal state of a monitored object, and transmits, to an abnormality monitoring/alarming apparatus (300) for sending out a warning to a person who causes the monitored object to have an abnormal state, abnormal state information (500) indicating the abnormal state. The detecting apparatus (200) includes transmitting means for transmitting, in accordance with a predetermined condition, the abnormal state information (500) to the abnormality monitoring/alarming apparatus (300), the abnormal state information (500) serving as confirmation information for confirming establishment of communication between the detecting apparatus (200) and the abnormality monitoring/alarming apparatus (300). This makes it possible to provide a detecting apparatus which makes it possible to (i) reduce power consumption of the detecting apparatus (200) and (ii) confirm whether or not information indicating a detection result can be properly transmitted to a destination.

### TECHNICAL FIELD

The present invention relates to a detecting apparatus, an abnormality monitoring system, a detecting apparatus control program, and a computer-readable recording medium storing the detecting apparatus control program, in which an abnormal state of an object to be monitored is detected and abnormal state information indicative of a detected abnormal state is transmitted to an information processing apparatus for sending out a warning to a person who causes the monitored object to have an abnormal state.

### BACKGROUND ART

Recently, there have been a large number of crimes such as vehicle break-ins and house break-ins. This causes people to be highly conscious of crime prevention. In response to the high consciousness of crime prevention, various products for crime-prevention have been developed.

For example, there is provided a vehicle theft preventing apparatus for protecting a parked vehicle from theft. The vehicle theft preventing apparatus includes: a sensor for detecting an abnormal state of a vehicle; and an alarm control section for intimidating a thief with a buzzer or the like in cases where the abnormal state of the vehicle is detected by the sensor.

Incidentally, in the case of a vehicle theft preventing apparatus in which the sensor and the alarm control section are connected to each other by wire, the wire needs to be provided so as not to hinder a person from getting on and off the vehicle. This causes trouble when the sensor is installed. In this case, it is difficult to install the sensor outside the vehicle.

In order to solve the problems, for example, Publicly-known Document 1 (Japanese Unexamined Patent Publication No. 308053/2002 (Tokukai 2002-308053; published on Oct. 23, 2002) proposes an arrangement of a vehicle theft preventing apparatus in which a sensor and an alarm control section are connected to each other by radio.

However, the vehicle theft preventing apparatus disclosed in Publicly-known Document 1 is arranged such that a result of detection carried out by the sensor is transmitted unidirectionally to the alarm control section. For this reason, the vehicle theft preventing apparatus raises such a problem that: especially when the sensor is installed, it is impossible to confirm whether or not the result of the detection carried out by the sensor is properly transmitted to the alarm control section.

On the other hand, when the vehicle theft preventing apparatus is arranged such that the sensor and the alarm control section are capable of exchanging information with each other, i.e., communicating with each other bi-directionally, it is possible to confirm, in accordance with an instruction given from the alarm control section, whether or not information indicative of the detection result can be properly transmitted from the sensor to the alarm control section. However, when a vehicle theft preventing apparatus is thus arranged such that a sensor and an alarm control section are capable of communicating with each other bi-directionally, the sensor needs to always maintain a standby state so as to be able to receive the information transmitted from the alarm control section. This causes the sensor to consume a large amount of power. For the purpose of supplementing the power that is to be consumed by the sensor, the sensor needs to be provided with a separate large battery and/or a separate power supply wire. This makes it difficult to easily install the sensor in the vehicle.

The present invention has been made in view of the foregoing problems, and it is an object of the present invention to provide a detecting apparatus which makes it possible to (i) reduce power consumption of the detecting apparatus and (ii) confirm whether or not information indicative of a detected result can be properly transmitted to a destination.

### DISCLOSURE OF INVENTION

In order to solve the foregoing problems, a detecting apparatus according to the present invention is a detecting apparatus for (i) detecting an abnormal state of a monitored object and (ii) transmitting, to an information processing apparatus, abnormal state information indicating the abnormal state, which information processing apparatus carries out a process in accordance with the abnormal state information, the detecting apparatus, including: transmitting means for transmitting confirmation information to the information processing apparatus in accordance with a predetermined condition, which confirmation information is information for confirming establishment of communication between the detecting apparatus and the information processing apparatus.

According to the foregoing arrangement, the detecting apparatus can transmit the confirmation information to the information processing apparatus in accordance with the predetermined condition. Therefore, the detecting apparatus makes it possible to confirm whether or not the detected abnormal state information can be properly transmitted to the information processing apparatus.

Note that the predetermined condition refers to such a condition that can be detected and determined by the detecting apparatus, such as (i) a change in environment surrounding the detecting apparatus and (ii) a temporal change in the detecting apparatus. Specifically, examples of the condition include: (a) a condition whether or not the predetermined period of time has elapsed since the detecting apparatus was installed in the monitored object; (b) a condition whether or not a predetermined rhythm of vibrations has been detected in the monitored object; and (c) a condition whether or not a predetermined sound has been detected in the monitored object.

Further, the detecting apparatus according to the present invention does not need to include receiving means for receiving, from another apparatus or the like, an instruction for transmitting the confirmation information, and therefore does not need to maintain a reception state in preparation for the reception. That is, the detecting apparatus does not need to maintain the reception standby state, and therefore allows reduction of power consumption therein.

Therefore, the detecting apparatus according to the present invention allows an effect of (i) reducing the power consumption therein and (ii) confirming whether or not information indicating a detection result can be properly transmitted to a destination.

Further, in the foregoing arrangement, the detecting apparatus according to the present invention may be arranged such that: the predetermined condition is information indicating that a predetermined period of time has elapsed; and the transmitting means transmits the confirmation information to the information processing apparatus after the predetermined period of time has elapsed.

According to the foregoing arrangement, the predetermined condition is the information indicating that the predetermined period of time has elapsed, and the detecting apparatus according to the present invention can transmit the confirmation information to the information processing apparatus after the predetermined period of time has elapsed. Therefore, the detecting apparatus makes it possible to confirm whether or not the information indicating the detection result can be properly transmitted to the destination.

Further, the detecting apparatus does not need to receive the instruction for transmitting the confirmation information, and therefore does not need to maintain the reception standby state. Therefore, the detecting apparatus makes it possible to reduce the power consumption of the detecting apparatus.

Further, in order to solve the foregoing problems, an abnormality monitoring system according to the present invention includes: the foregoing detecting apparatus; and an information processing apparatus for carrying out a process in accordance with either (i) abnormal state information or (ii) the confirmation information each of which is transmitted by the detecting apparatus.

Therefore, the abnormality monitoring system according to the present invention allows an effect of (i) reducing the power consumption of the detecting apparatus and (ii) confirming whether or not the information indicating the detection result can be properly transmitted to the destination, i.e., the information processing apparatus.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 shows an embodiment of the present invention, and is a block diagram showing an arrangement of a main portion of a detecting apparatus provided in an abnormality monitoring system.

FIG. 2 shows the embodiment of the present invention, and is a block diagram showing an arrangement of a main portion of the abnormality monitoring system.

FIG. 3 shows the embodiment of the present invention, and is a block diagram showing an arrangement of a main portion of an abnormality monitoring/alarming apparatus provided in the abnormality monitoring system.

FIG. 4 is a flow chart illustrating an example of a process which is carried out in the detecting apparatus according to the embodiment and in which abnormal state information is transmitted as confirmation information to the abnormality monitoring/alarming apparatus.

FIG. 5 is a diagram showing (i) examples of purposes of monitoring and (ii) examples of sensors respectively selected in accordance with the purposes of monitoring.

FIG. 6 shows another embodiment of the present invention, and is a block diagram showing an arrangement of a main portion of a detecting apparatus provided in an abnormality monitoring system.

FIG. 7 is a flow chart illustrating an example of a process which is carried out in the detecting apparatus according to the embodiment and in which abnormal state information is transmitted as confirmation information to the abnormality monitoring/alarming apparatus.

FIG. 8 shows still another embodiment of the present invention, and is a block diagram showing a main portion of a detecting apparatus provided in an abnormality monitoring system.

FIG. 9 is a flow chart illustrating an example of a process which is carried out in the detecting apparatus according to the embodiment and in which the abnormal state information is transmitted as confirmation information to abnormality monitoring/alarming apparatus.

### BEST MODE FOR CARRYING OUT THE INVENTION

The following description deals with the present invention further in detail based on Embodiments and Comparative Examples. However, the present invention is not limited to these Embodiments and Comparative Examples.

### Embodiment 1

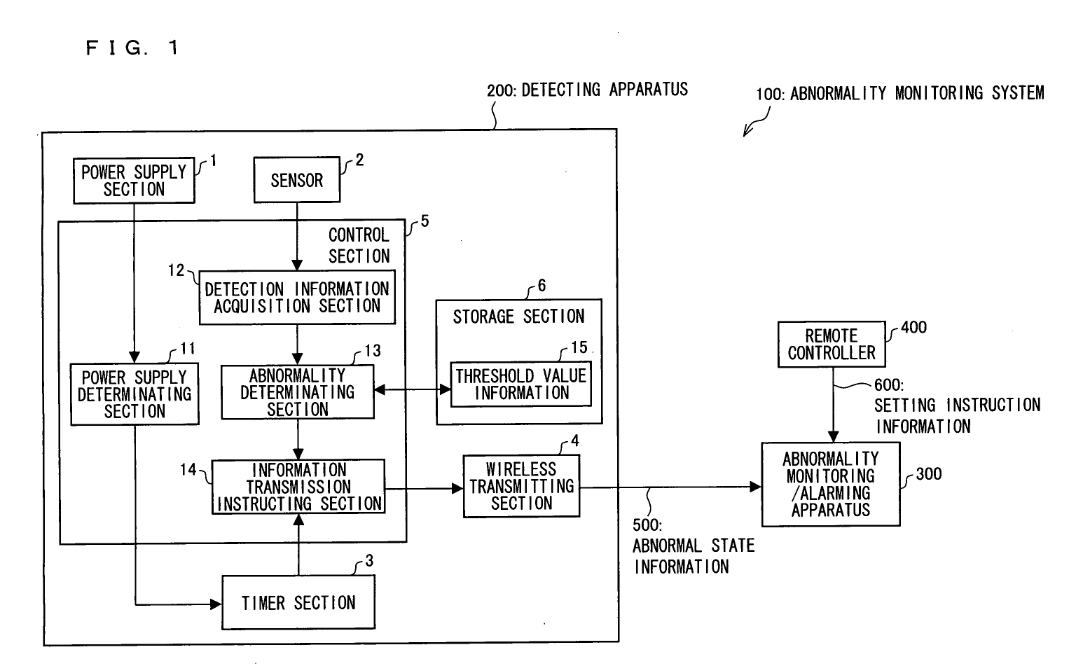

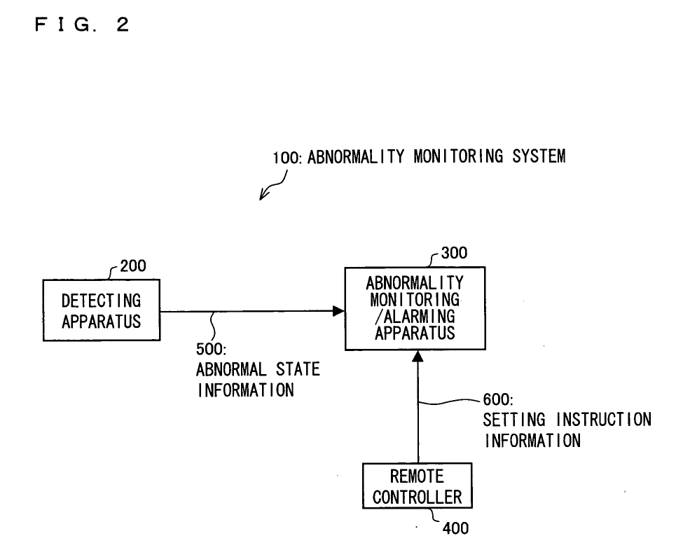

One embodiment of the present invention will be described below with reference to FIGS. 1 through 5. Specifically, as shown in FIG. 2, an abnormality monitoring system 100 according to the present embodiment is arranged so as to include a detecting apparatus 200, an abnormality monitoring/alarming apparatus (information processing apparatus) 300, and a remote controller 400. FIG. 2 shows an embodiment of the present invention, and is a block diagram showing an arrangement of a main portion of the abnormality monitoring system 100.

The detecting apparatus 200 detects a state of a vehicle, i.e., an object to be monitored (monitored object), and is installed in an appropriate place of the vehicle in accordance with a purpose of monitoring. In cases where the detecting apparatus 200 determines, in accordance with a result of the detection, that the vehicle is in an abnormal state, the detecting apparatus 200 transmits, to the abnormality monitoring/alarming apparatus 300, abnormal state information 500 indicative of the abnormal state.

Note that the detecting apparatus 200 transmits the abnormal state information 500 to the abnormality monitoring/alarming apparatus 300 by way of wireless communication using radio waves or infrared rays.

Meanwhile, the abnormality monitoring/alarming apparatus 300 sends out, in accordance with the abnormal state information 500 transmitted from the detecting apparatus 200, a warning to a person who has caused the vehicle, i.e., the monitored object to have the abnormal state. The abnormality monitoring/alarming apparatus 300 can be switched from an alert state to a non-alert state, or vice versa, in accordance with setting instruction information 600 transmitted from the remote controller 400. In the alert state, when the abnormality monitoring/alarming apparatus 300 receives abnormal state information 500 from the detecting apparatus 200, the abnormality monitoring/alarming apparatus 300 sends out a warning to a person who has caused the vehicle to have the abnormal state. On the other hand, in the non-alert state, the abnormality monitoring/alarming apparatus 300 sends out no warning even when the abnormality monitoring/alarming apparatus 300 receives abnormal state information 500 from the detecting apparatus 200.

Thus, the abnormality monitoring/alarming apparatus 300 can switch from an alert state to a non-alert state or vice versa. This makes it possible to prevent a faulty operation in which the abnormality monitoring/alarming apparatus 300 sends out a warning when the detecting apparatus 200 detects vibrations caused by an authorized user's driving of the vehicle.

(Arrangement of the Abnormality Monitoring/alarming Apparatus)

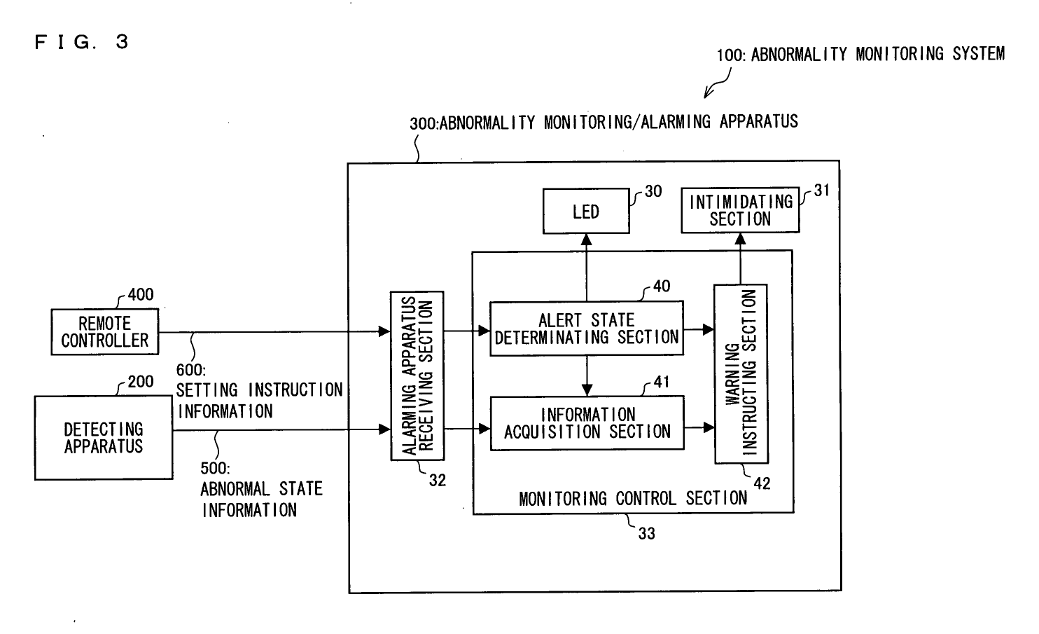

The following explains an arrangement of the abnormality monitoring/alarming apparatus 300 with reference to FIG. 3. FIG. 3 shows an embodiment of the present invention, and is a block diagram showing an arrangement of a main portion of the abnormality monitoring/alarming apparatus 300 in the abnormality monitoring system 100.

As shown in FIG. 3, the abnormality monitoring/alarming apparatus 300 includes an LED 30, an intimidating section 31, an alarming apparatus receiving section 32, and a monitoring control section 33.

The alarming apparatus receiving section 32 receives, under the control of the monitoring control section 33, the abnormal state information 500 transmitted from the detecting apparatus 200. Alternatively, the alarming apparatus receiving section 32 receives, under the control of the monitoring control section 33, the setting instruction information 600 which is transmitted from the remote controller 400 and which instructs the abnormality monitoring/alarming apparatus 300 to be set in an alert state or in a non-alert state.

The LED 30 indicates, in accordance with an instruction given from the monitoring control section 33, whether the abnormality monitoring/alarming apparatus 300 has been set to an alert state or a non-alert state. Specifically, in cases where the abnormality monitoring/alarming apparatus 300 is set to an alert state, the LED 30 blinks so as to indicate that the abnormality monitoring/alarming apparatus 300 is in an alert state.

The intimidating section 31 carries out a warning operation in accordance with the instruction given from the monitoring control section 33. Specifically, the intimidating section 31 carries out a warning operation of sounding an intimidating buzzer.

The monitoring control section 33 controls various operations of each of the members of the abnormality monitoring/alarming apparatus 300, and includes an alert state determinating section 40, an information acquisition section 41, and a warning instructing section 42 as functional blocks. Note that the sections respectively represented as the functional blocks can be realized by a CPU's (central processing unit) executing of a program which is read out from a storage device such as a ROM (read only memory) (not shown) to a RAM (random access memory) or the like. That is, the members, the alert state determinating section 40, the information acquisition section 41, and the warning instructing section 42 are functional blocks which are realized by the CPU's controlling of a peripheral circuit(s) (not shown) such as an input/output circuit and by CPU's executing of the program stored in the storage device.

The information acquisition section 41 acquires, via the alarming apparatus receiving section 32, the abnormal state information 500 transmitted from the detecting apparatus 200. The information acquisition section 41 transmits the abnormal state information 500 to the warning instructing section 42.

The alert state determinating section 40 determines whether the abnormality monitoring/alarming apparatus 300 is to be set to an alert state or a non-alert state. Specifically, the abnormality monitoring apparatus 300 according to the present embodiment can be switched from an alert state to a non-alert state, or vice versa, in accordance with the setting instruction information 600 transmitted from the remote controller 400. When the setting instruction information 600 is transmitted from the remote controller 400 to the abnormality monitoring/alarming apparatus 300, the alarming apparatus receiving section 32 receives the instruction, and then sends it to the alert state determinating section 40.

The alert state determinating section 40 instructs, in accordance with the setting instruction information 600 transmitted from the remote controller 400, the warning instructing section 42 to cause the abnormality monitoring/alarming apparatus 300 to be in an alert state or a non-alert state. Meanwhile, the alert state determinating section 40 instructs the LED 30 to indicate the state instructed by the remote controller 400. Thus, the LED 30 indicates, in accordance with the instruction given from the alert state determinating section 40, whether the abnormality monitoring/alarming apparatus 300 is in an alert state or a non-alert state.

Further, the warning instructing section 42 causes the abnormality monitoring/alarming apparatus 300 to be in an alert state or a non-alert state in accordance with the instruction given from the alert state determinating section 40.

Moreover, in an alert state, when the warning instructing section 42 receives the abnormal state information 500 from the information acquisition section 41, the warning instructing section 42 instructs the intimidating section 31 to send out a warning. On the other hand, in a non-alert state, the warning instructing section 42 gives no instruction to the intimidating section 31 even when the warning instructing section 42 receives the abnormal state information 500 from the information acquisition section 41.

As described above, the abnormality monitoring/alarming apparatus 300 according to the present embodiment is arranged so as to be able to switch from an alert state to a non-alert state, or vice versa, in accordance with the setting instructing information 600 transmitted from the remote controller 400. Further, the abnormality monitoring/alarming apparatus 300 is arranged such that: when the abnormality monitoring/alarming apparatus 300 is in an alert state, the intimidating section 31 carries out a warning operation of sounding an intimidating buzzer in accordance with the abnormality state information 500 transmitted from the detecting apparatus 200.

Therefore, in cases where an abnormal state occurs in a vehicle, i.e., a monitored object, the abnormality monitoring/alarming apparatus 300 according to the present embodiment can sound an intimidating buzzer acting as a warning to a person who has caused the monitored object to have such an abnormal state.

(Arrangement of Detecting Apparatus)

With reference to FIG. 1, the following explains an arrangement of the detecting apparatus 200 according to the present embodiment. FIG. 1 shows an embodiment of the present invention, and is a block diagram showing an arrangement of a main portion of the detecting apparatus 200 in the abnormality monitoring system 100.

As shown in FIG. 1, the detecting apparatus 200 includes a power supply section 1, a sensor 2, a timer section 3, a wireless transmitting section 4, a control section 5, and a storage section 6.

The power supply section 1 supplies power for causing the detecting apparatus 200 to work, and the detecting apparatus 200 according to the present embodiment is designed to be driven by a battery.

The sensor 2 is a sensor for detecting a physical phenomenon which has occurred in a vehicle, and transmits detected information to the control section 5.

Specifically, for the purpose of monitoring a theft of wheels, tires, interior parts, parts, or the like from the vehicle, a vibration sensor for detecting vibration caused during the theft is used as the sensor 2. The vibration sensor is installed appropriately in a position that is to be vibrated during the theft of the wheels, the tires, the interior parts, the parts, or the like. That is, the vibration sensor is fixed directly to an externally invisible metal portion of the vehicle so as to effectively detect the vibration of the vehicle. Examples of such an externally invisible metal portion include a metal portion of a side surface of a spare tire housing provided in a trunk.

The timer section 3 measures a predetermined period of time having elapsed since a reception of a notification, indicating that the power supply has started, from the control section 5. Specifically, when a battery, serving as the power supply section 1, is connected and starts the power supply, the control section 5 determines a timing at which the power supply has started, and then informs of the timing to the timer section 3. In response to the informing from the control section 5, the timer section 3 starts to measure time. When the predetermined period of time has elapsed, the timer section 3 transmits, to the control section 5, time information indicating that the predetermined period of time has elapsed.

The wireless transmitting section 4 transmits the abnormal state information 500 to the abnormality monitoring/alarming apparatus 300 wirelessly in accordance with an instruction given from the control section 5.

As with a flash memory, the storage section 6 serves to permanently store data. Moreover, the storage section 6 stores threshold value information 15. The threshold value information 15 is used by the control section 5 so that the control section 5 determines, in accordance with a detection result of detection carried out by the sensor 2, whether or not an abnormal state has occurred.

The control section 5 controls various operations of each of the members of the detecting apparatus 200, and includes a power supply determinating section 11, a detection information acquisition section 12, an abnormality determinating section 13, and an information transmission instructing section 14 as functional blocks. Note that the sections respectively represented as the functional blocks can be realized when the control section 5 that can be realized by a CPU executes a program read out from a storage device such as a ROM (not shown) to a RAM or the like. That is, the members, the power supply determinating section 11, the detection information acquisition section 12, the abnormality determinating section 13, and the information transmission instructing section 14 are functional blocks which are realized by the CPU's controlling of a peripheral circuit(s) (not shown) such as an input/output circuit and by the CPU's executing of the program stored in the storage device.

The detection information acquisition section 12 acquires detection result information indicative of a result detected by the sensor 2, and transmits the detection result information to the abnormality determinating section 13.

The abnormality determinating section 13 determines whether or not the detection result information transmitted from the sensor 2 indicates that an abnormal state has occurred in a vehicle. Specifically, the abnormality determinating section 13 refers to the threshold value information 15 stored in the storage section 6, and determines whether or not a physical quantity of the vibration detected by the sensor 2 is not less than a predetermined threshold value. In cases where the abnormality determinating section 13 determines that the physical quantity of the vibration is less than the predetermined threshold value, the vibration detected by the sensor 2 is treated, for example, as a detection error such as vibration caused by another vehicle which has passed by the vehicle.

On the other hand, in cases where the abnormality determinating section 13 determines that the physical quantity of the vibration is not less than the predetermined threshold value, the vibration detected by the sensor 2 is determined to be vibration indicative of an abnormal state. Then, the determined result is transmitted to the information transmission instructing section 14.

The information transmission instructing section 14 generates, in accordance with the determined result transmitted from the abnormality determinating section 13, the abnormal state information 500 indicative of the abnormal state, and instructs the wireless transmitting section 4 to transmit the abnormal state information 500 to the abnormality monitoring/alarming apparatus 300. Further, also in cases where the information transmission instructing section 14 receives the time information from the timer section 3, the information transmission instructing section 14 generates the abnormal state information 500, and instructs the wireless transmitting section 4 to transmit the abnormal state information 500 to the abnormality monitoring/alarming apparatus 300.

Note that the information transmission instructing section 14 instructs the wireless transmitting section 4 to transmit, three times, the abnormal state information 500 to the abnormality monitoring/alarming apparatus 300. This is because the transmission of the abnormal state information 500 may be prevented by noise or the like generated between the detecting apparatus 200 and the abnormality monitoring/alarming apparatus 300. By thus transmitting the abnormal state information 500 three times, the transmission of the abnormal state information 500 is surely carried out.

As described above, the detecting apparatus 200 according to the present embodiment is arranged such that: when the predetermined period of time has elapsed since the detecting apparatus 200 started to be supplied with the power, the timer section 3 notifies the information transmission instructing section 14 of the time information indicating that the predetermined period of time has elapsed; and the information transmission instructing section 14 controls the wireless transmitting section 4 in accordance with the notification so that the wireless transmitting section 4 transmits the abnormal state information 500 to the abnormality monitoring/alarming apparatus 300.

That is, the detecting apparatus 200 transmits the abnormal state information 500 to the abnormality monitoring/alarming apparatus 300 either in (i) the case where the information transmission instructing section 14 receives, from the abnormality determinating section 13, a determined result indicating that an abnormal state occurs, or (ii) the case where the information transmission instructing section 14 receives the time information from the timer section 3. The abnormal state information 500 in the latter case is transmitted not because an abnormality has occurred in a monitored object portion provided with the detecting apparatus 200, but is transmitted as confirmation information for confirming whether or not the abnormal state information 500 is properly transmitted from the detecting apparatus 200 to the abnormality monitoring/alarming apparatus 300. When the abnormal state information 500 is thus transmitted as the confirmation information from the detecting apparatus 200 to the abnormality monitoring/alarming apparatus 300, the abnormality monitoring/alarming apparatus 300 carries out, in accordance with the abnormal state information 500, the intimidating operation of sending out a warning.

(Process 1 of Transmitting Abnormal State Information as Confirmation Information)

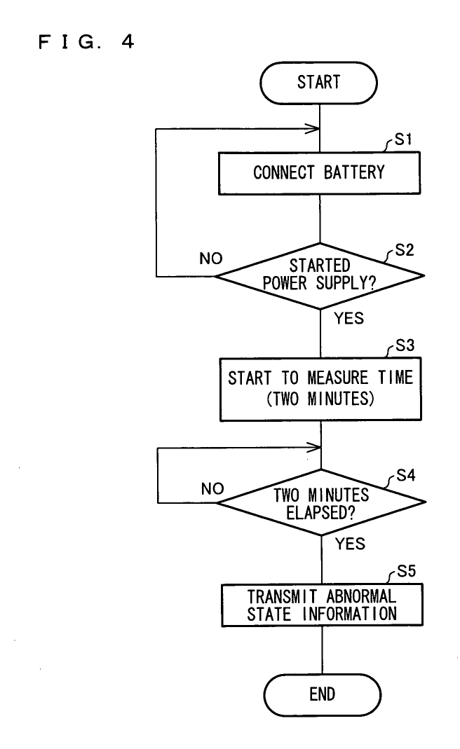

With reference to FIG. 4, the following explains a flow of a process in which the detecting apparatus 200 transmits the abnormal state information 500 as the confirmation information to the abnormality monitoring/alarming apparatus 300. Note that FIG. 4 is a flow chart explaining an example of the process which is carried out in the detecting apparatus 200 according to the present embodiment and in which the abnormal state information 500 is transmitted as the confirmation information to the abnormality monitoring/alarming apparatus 300.

See FIG. 4. First, when a connecting of battery, acting as the power source, is carried out in the detecting apparatus 200 (S1), the power supply determinating section 11 of the control section 5 determines whether or not the power supply has started (S2). In cases where the power supply determinating section 11 of the control section 5 determines that the power supply has started (“YES” in S2), the power supply determinating section 11 instructs the timer section 3 to measure time (S3). The timer section 3 is set so as to measure two minutes. The detecting apparatus 200 is in a waiting state until the timer section 3 finishes measuring the two minutes (“NO” in S4). During the two minutes, the vehicle is in a normal parking state, and the user sets the abnormality monitoring/alarming apparatus 300 to be in an alert state by using the remote controller 400.

On the other hand, when the timer section 3 finishes measuring the two minutes (“YES” in S4), the timer section 3 instructs the information transmission instructing section 14 of the control section 5 to transmit the abnormal state information 500 serving as the confirmation information. In accordance with the instruction, the information transmission instructing section 14 of the control section 5 instructs the wireless transmitting section 4 to transmit the abnormal state information 500 to the abnormality monitoring/alarming apparatus 300 (S5).

As described above, according to the detecting apparatus 200 of the present embodiment, it is possible to transmit the abnormal state information 500 as the confirmation information to the abnormality monitoring/alarming apparatus 300, after two minutes elapses from the start of the power supply.

Therefore, according to the abnormality monitoring system 100 of the present embodiment, it is possible for a user to confirm whether or not the abnormal state information 500 is properly transmitted from the detecting apparatus 200 to the abnormality monitoring/alarming apparatus 300.

Further, the detecting apparatus 200 does not need to receive, from the abnormality monitoring/alarming apparatus 300, an instruction for requesting the abnormal state information 500 to be transmitted as the confirmation information. Therefore, it is not necessary to maintain a standby state in preparation for the reception. As such, it is possible to reduce power consumption in the detecting apparatus 200.

Particularly, as described above, in a vehicle, a detecting apparatus 200 is installed in a place that cannot be or can hardly be seen from outside. That is, the detecting apparatus 200 is installed in such a place that it is difficult for the user to operate the detecting apparatus 200 by directly touching the detecting apparatus 200. This makes it impossible for the user to confirm, by directly operating the detecting apparatus 200, whether or not the abnormal state information 500 is properly transmitted from the detecting apparatus 200 to the abnormality monitoring/alarming apparatus.

Therefore, the detecting apparatus 200 according to the present embodiment is arranged so as to be able to transmit the abnormality information 500 to the abnormality monitoring/alarming apparatus 300 after the predetermined period of time (two minutes) has elapsed. With this, even in cases where the user cannot directly operate the detecting apparatus 200, the user can confirm whether or not the abnormal state information 500 is properly transmitted.

Further, the detecting apparatus 200 uses the vibration sensor as the sensor 2. However, the present invention is not limited to this.

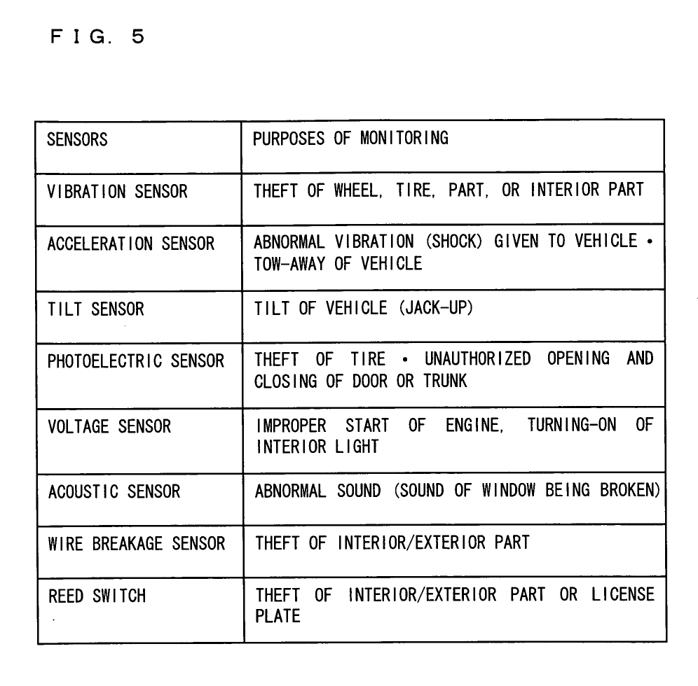

That is, as shown in FIG. 5, it is preferable that appropriate types of sensors be disposed in appropriate places in accordance with (i) monitored object portions of the vehicle and (ii) purposes of monitoring, respectively. Note that FIG. 5 is a diagram showing (a) examples of the purposes of monitoring and (b) examples of the sensors respectively selected in accordance with the purposes of monitoring.

For example, for the purpose of monitoring (i) an abnormal vibration (shock) given to the vehicle or (ii) a tow-away of the vehicle, the sensor 2 may be an acceleration sensor for detecting acceleration caused by the vehicle's moving from one place to another. Further, for example, for the purpose of detecting a tilt of the vehicle being jacked up, the sensor 2 may be a tilt sensor.

Further, for example, for the purpose of monitoring (i) a theft of a tire or wheel or (ii) improper opening and closing of a door or trunk by an unauthorized person, the sensor 2 may be a photoelectric sensor. The photoelectric sensor is installed in such a position as to be able to detect light that falls on the photoelectric sensor due to (a) the removal of the tire or wheel or (b) the improper opening and closing of the door or trunk.

Further, for the purpose of monitoring (i) a start of an engine by an unauthorized person (improper engine start) or (ii) a forcible entry into the vehicle by an unauthorized person, the sensor 2 may be a voltage sensor for detecting (a) a voltage change caused by the engine start or (b) a voltage change of an interior light that is turned on when the door or the like is opened.

Further, for the purpose of monitoring breakage of a window of the vehicle, the sensor 2 may be an acoustic sensor for detecting only a high-frequency sound caused by the window breakage.

Further, for the purpose of monitoring a theft of an interior/exterior part wired so as to be supplied with the power, the sensor 2 may be a wire breakage sensor for detecting wire breakage.

Further, for the purpose of monitoring a theft of an interior/exterior part or license plate each of which is connected by a magnet, the sensor 2 may be a reed switch that switches between ON and OFF in accordance with intensity of magnetic force.

Further, in the detecting apparatus 200 according to the present embodiment, it is preferable that a sensor be selected as the sensor 2 in accordance with a purpose of monitoring. Moreover, such a detecting apparatus 200 is installed in a vehicle so as to be put in an appropriate position, especially in a position that cannot be or can hardly be seen from outside. FIG. 5 shows an example of combinations of the sensors and the purposes of monitoring, but the sensor 2 is not limited to these sensors. Further, in the abnormality monitoring system 100 according to the present embodiment, all the sensors shown in FIG. 5 may be provided. Alternatively, some of the sensors may be combined in accordance with a purpose(s) of monitoring, and may be installed in a vehicle so as to be respectively put in appropriate positions.

Further, although the detecting apparatus 200 according to the present embodiment is arranged such that the abnormal state information 500 is transmitted as the confirmation information to the abnormality monitoring/alarming apparatus 300 two minutes after the start of the power supply, the confirmation information may be different from the abnormal state information 500. That is, the information transmitted to the abnormality monitoring/alarming apparatus 300 in cases where occurrence of an abnormal state is determined in accordance with the result of the detection carried out by the sensor 2 may be different from the information that is transmitted to the abnormality monitoring/alarming apparatus 300 at a predetermined timing in accordance with the instruction given from the timer section 3.

However, in the case where the detecting apparatus 200 is arranged so as to transmit the abnormal state information 500 and the confirmation information that are different from each other, the abnormality monitoring/alarming apparatus 300 needs to be provided with means for determining whether the information transmitted from the detecting apparatus 200 is the abnormal state information 500 or the confirmation information. Therefore, for the purpose of simplification of processes carried out in the abnormality monitoring/alarming apparatus 300, it is preferable that the abnormal state information 500 be transmitted, as both the abnormal state information 500 and the confirmation information, to the abnormality monitoring/alarming apparatus 300.

Further, the detecting apparatus 200 according to the present embodiment is arranged such that: the timer section 3 measures the predetermined period of two minutes. However, the time to be measured is not limited to this as long as it is long enough for the user to (i) install the detecting apparatus 200 in the vehicle, (ii) put the vehicle in a normal parking state, and (iii) set the abnormality monitoring/alarming apparatus 300 in the alert state. For example, the time to be measured may be one minute or may be three minutes.

Further, the detecting apparatus 200 according to the present embodiment is arranged such that: the timer section 3 measures the predetermined period of two minutes after the battery is so connected as to start the power supply. However, the detecting apparatus 200 may be arranged such that: the detecting apparatus 200 includes a power switch, and the power supply is started by turning ON the power switch.

Further, the detecting apparatus 200 according to the present embodiment is arranged such that: the timer section 3 measures the predetermined period of time having elapsed since the start of the power supply. However, the detecting apparatus 200 may be arranged such that: the detecting apparatus 200 has been already supplied with the power, and the timer section 3 measures a predetermined period of time having elapsed since pressing of a button provided in the detecting apparatus 200.

Further, the abnormality monitoring system 100 according to the present embodiment is arranged such that: the detecting section 200 includes the timer section 3, and transmits the abnormal state information 500 to the abnormality monitoring/alarming apparatus 300 after the predetermined period of time (two minutes) has elapsed, so that it is possible to confirm whether or not the abnormal state information 500 can be properly transmitted. However, as shown in Embodiment 2 or Embodiment 3, the detecting apparatus 200 may be arranged differently.

### Embodiment 2

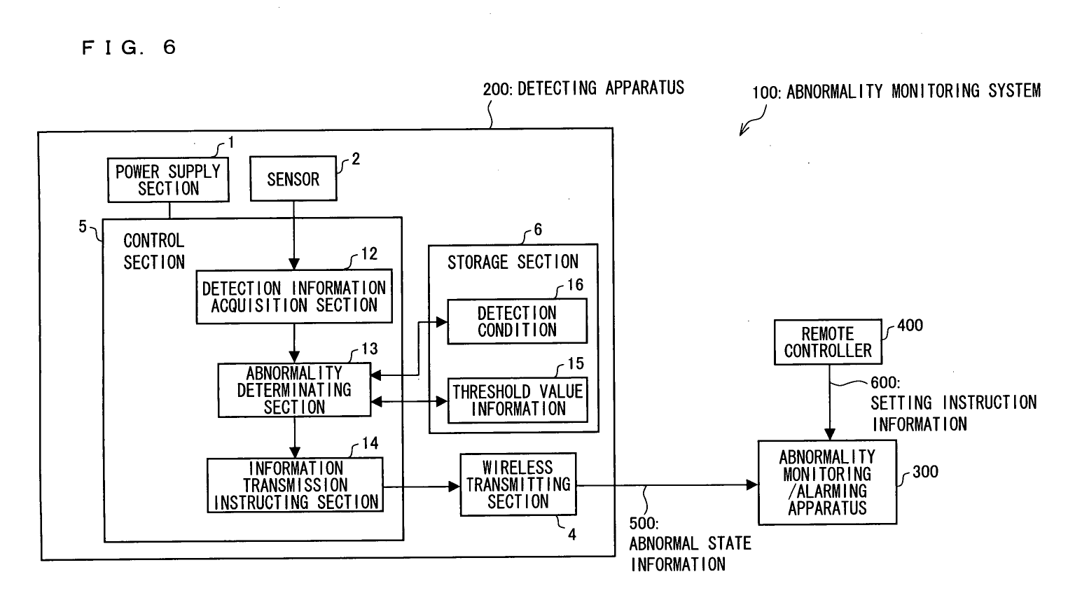

As shown in FIG. 6, a detecting apparatus 200 according to the present embodiment is different from the detecting apparatus 200 according to Embodiment 1 in that the detecting apparatus 201 has no timer section 3, and has a control section 5 having no power supply determinating section 11.

Further, the detecting apparatus 200 according to the present embodiment is also different from the detecting apparatus 200 according to Embodiment 1 in that the detecting apparatus 200 according to the present embodiment has a storage section 6 storing a detection condition 16. Furthermore, the detecting apparatus 200 according to the present embodiment is also different from the detecting apparatus 200 according to Embodiment 1 in that: an abnormal determinating section 13 of the control section 5 refers to the detection condition 16 and threshold value information 15 that are stored in the storage section 6, in order to determine either (i) whether detection result information acquired by the detection information acquisition section 12 is information indicative of an abnormal state, i.e., information indicating that a vibration detected by the sensor 2 is an abnormal one, or (ii) whether the detection result information is confirmation information. FIG. 6 shows another embodiment of the present invention, and is a block diagram showing an arrangement of a main portion of the detecting apparatus 200 provided in the abnormality monitoring system 100.

That is, as shown in FIG. 6, the detecting apparatus 200 according to the present embodiment is arranged such that: the storage section 6 further stores the detection condition 16; and the abnormality determinating section 13 refers to the threshold value information 15 and the detection condition 16 in order to determine whether the detection result information transmitted from the sensor 2 indicates an abnormal state or a request for confirmation information. A result of the determination is notified to the information transmission instructing section 14, both (i) when the abnormality determinating section 13 determines that the detection result information transmitted from the sensor 2 indicates an abnormal state, and (ii) when the abnormality determinating section 13 determines that the detection result information transmitted from the sensor 2 indicates a request for confirmation information. In response to the notification given from the abnormality determinating section 13, the information transmission instructing section 14 controls the wireless transmitting section 4 such that the abnormal state information 500 is transmitted to the abnormality monitoring/alarming apparatus 300.

The detection condition 16 refers to a predetermined detection result for the detection carried out by the sensor 2. Specifically, assume that the detecting apparatus 200 is arranged such that: the abnormal state information 500 is transmitted as the confirmation information when the detection result of the detection carried out by the sensor 2 indicates a series of a predetermined number of vibrations, e.g., three continuous vibrations. In such a case, the storage section 6 stores, as the detection condition 16, a condition of detecting three continuous vibrations.

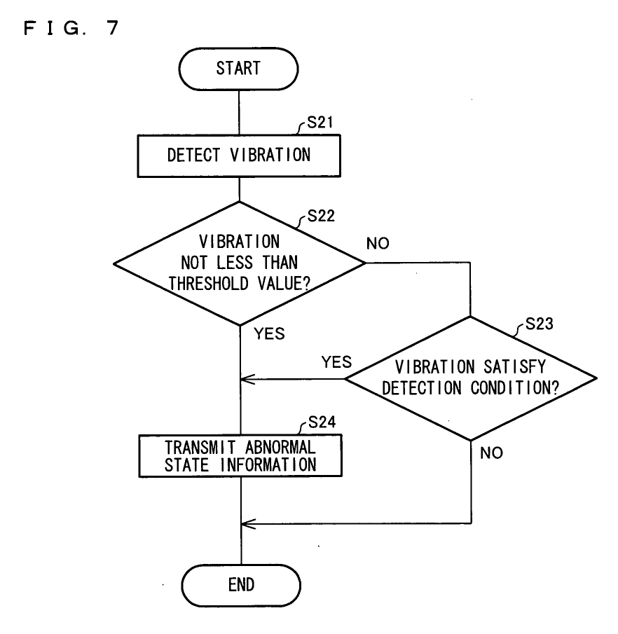

That is, the detecting apparatus 200 according to the present embodiment can transmit the abnormal state information 500 as the confirmation information as shown in a process flow of FIG. 7. Note that FIG. 7 is a flow chart illustrating an example of processes which are carried out by the detecting apparatus 200 according to the embodiment and in which the abnormal state information 500 is transmitted as the confirmation information to the abnormality monitoring/alarming apparatus 300.

(Process 2 of Transmitting Abnormal State Information as Confirmation Information)

First, the sensor 2 detects a vibration (S21). The detection information acquisition section 12 acquires detection result information indicating a result of the detection carried out by the sensor 2, and transmits the detection result information to the abnormality determinating section 13. In accordance with the detection result information transmitted from the detection information acquisition section 12, the abnormality determinating section 13 determines whether or not a physical quantity of the vibration detected by the sensor 2 is not less than a threshold value (S22). In cases where the abnormality determinating section 13 determines that the physical quantity of the vibration is not less than the threshold value (“YES” in S22), the abnormality determinating section 13 notifies the information transmission instructing section 14 of information indicating that the vehicle is in an abnormal state.

On the other hand, in cases where the abnormality determinating section 13 determines that the physical quantity of the vibration detected by the sensor 2 is less than the threshold value (“NO” in S22), the abnormality determinating section 13 determines whether or not the vibration satisfies the detection condition 16 (S23). In cases where the abnormality determinating section 13 determines that the vibration satisfies the detection condition 16 (“YES” in S23), the abnormality determinating section 13 notifies the information transmission instructing section 14 of information indicating that the determination result indicates a request for confirmation information.

Upon receiving the notification of the determination carried out by the abnormality determinating section 13, i.e., upon receiving the notification of the abnormal state or the notification of a request for confirmation information, the information transmission instructing section 14 controls the wireless transmitting section 4 such that the abnormal state information 500 is transmitted to the abnormality monitoring/alarming apparatus 300 (S24).

The detecting apparatus 200 according to the present embodiment can transmit the abnormal state information 500 as the confirmation information to the abnormality monitoring/alarming apparatus 300 when the user vibrates the vehicle in such a manner as to satisfy the predetermined condition (three continuous vibrations, each of whose physical quantity is less than the threshold value).

This makes it unnecessary for the detecting apparatus 200 according to the present embodiment to include a receiving section for receiving an instruction for transmitting confirmation information. Therefore, the detecting apparatus 200 does not need to maintain a standby state in preparation for the reception.

That is, the detecting apparatus 200 does not need to maintain the reception standby state, and therefore allows reduction of power consumption therein.

Therefore, a detecting apparatus according to the present invention allows an effect of (i) reducing power consumption therein and (ii) confirming whether or not information indicating a detection result can be properly transmitted to a destination.

Note that: the detection condition 16 herein is three continuous vibrations, each of whose physical quantity is less than the threshold value, but is not limited to this.

For example, in cases where the detecting apparatus 200 uses an acoustic sensor as the sensor 2, the detecting apparatus 200 may be arranged such that: the abnormal state information 500 serving as the confirmation information is transmitted to the abnormality monitoring/alarming apparatus 300 when the predetermined number of high-frequency metallic sounds are generated by lightly hitting a bumper portion of the vehicle with a metal bar. In such a case, the detection condition 16 is a predetermined number of continuous sounds, each of whose physical quantity is not more than a threshold value.

Further, for example, in cases where the detecting apparatus 200 uses a sound pressure sensor as the sensor 2, the detecting apparatus 200 may be arranged such that: abnormal state information 500 serving as confirmation information is transmitted to the abnormality monitoring/alarming apparatus 300 in response to knocking on a body of the vehicle consecutively for a predetermined number of times. In such a case, the detection condition 16 is the predetermined number of continuous sounds, each of whose physical quantity is not more than a threshold value.

Further, for example, in cases where the detecting apparatus 200 uses an acceleration sensor as the sensor 2, the detecting apparatus 200 may be arranged such that: abnormal state information 500 is transmitted as confirmation information to the abnormality monitoring/alarming apparatus 300 when a swinging movement generated by pushing the bumper or body up and down, back and forth, or right and left causes acceleration having a value not less than a preset value.

Further, the detecting apparatus 200 may be arranged so as to be a combination of (i) the arrangement described in Embodiment 1 and (ii) the arrangement described in Embodiment 2, i.e., in the present embodiment. That is, although the detecting apparatus 200 according to Embodiment 1 is arranged such that the information transmission instructing section 14 transmits the abnormal state information 500 to the abnormality monitoring/alarming apparatus 300 after the predetermined period of time (two minutes) has elapsed, the detecting apparatus 200 may be arranged in the following manner.

That is, the detecting apparatus 200 may be arranged such that: the abnormal state information 500 is notified to the abnormality monitoring/alarming apparatus 300 when the sensor 2 detects, within the two minutes after the start of the power supply, three continuous vibrations, each of whose physical quantity is not more than the threshold value. In other words, the detecting apparatus 200 transmits the abnormal state information 500 as the confirmation information to the abnormality monitoring/alarming apparatus 300 in such a case that: the abnormality determination 13 receives notification indicating that the detection result information represents a request for confirmation information, before the information transmission instructing section 14 receives, from the timer section 3, notification indicating that two minutes has elapsed.

Further, as described above, the detecting apparatus 200 according to the present embodiment is arranged such that: the abnormality determinating section 13 refers to the threshold value information 15 and the detection condition 16, and determines whether the detection result information transmitted from the sensor 2 indicates an abnormal state or a request for confirmation information. In light of this, the detecting apparatus 200 may be arranged so as to limit the number of times the abnormality determinating section 13 determines whether or not the detected vibration satisfies the detection condition 16. Assume that the number of times is limited to three. In such a case, when the sensor 2 detects a vibration which satisfies the detection condition 16 but which is a fourth or subsequent vibration that satisfies the detection condition 16, the abnormality determinating section 13 does not give an instruction for transmitting the abnormal state information 500 as the confirmation information.

By thus arranging the detecting apparatus 200, it is possible to prevent the abnormal state information 500 from being transmitted as the confirmation information to the abnormality monitoring/alarming apparatus 300 every time the vibration satisfying the detection condition 16 is detected.

Further, although the detecting apparatus 200 according to the present embodiment is arranged such that the abnormal state information 500 is transmitted as the confirmation information to the abnormality monitoring/alarming apparatus 300, the confirmation information may be different from the abnormal state information 500. That is, the information transmitted to the abnormality monitoring/alarming apparatus 300 in cases where occurrence of an abnormal state is determined by the abnormality determinating section 13 determines, in accordance with the result of the detection carried out by the sensor 2 may be different from the information that is transmitted to the abnormality monitoring/alarming apparatus 300 in cases where the abnormality determinating section 13 determines that the result of the detection carried out by the sensor 2 indicates the request for the confirmation information.

However, in the case where the detecting apparatus 200 is arranged so as to transmit the abnormal state information 500 and the confirmation information that are different from each other, the abnormality monitoring/alarming apparatus 300 needs to be provided with means for determining whether the information transmitted from the detecting apparatus 200 is the abnormal state information 500 or the confirmation information. Therefore, for the purpose of simplification of processes carried out in the abnormality monitoring/alarming apparatus 300, it is preferable that the abnormal state information 500 be transmitted, as both the abnormal state information 500 and the confirmation information, to the abnormality monitoring/alarming apparatus 300.

Further, the detecting apparatus 200 may be arranged as described below in Embodiment 3.

### Embodiment 3

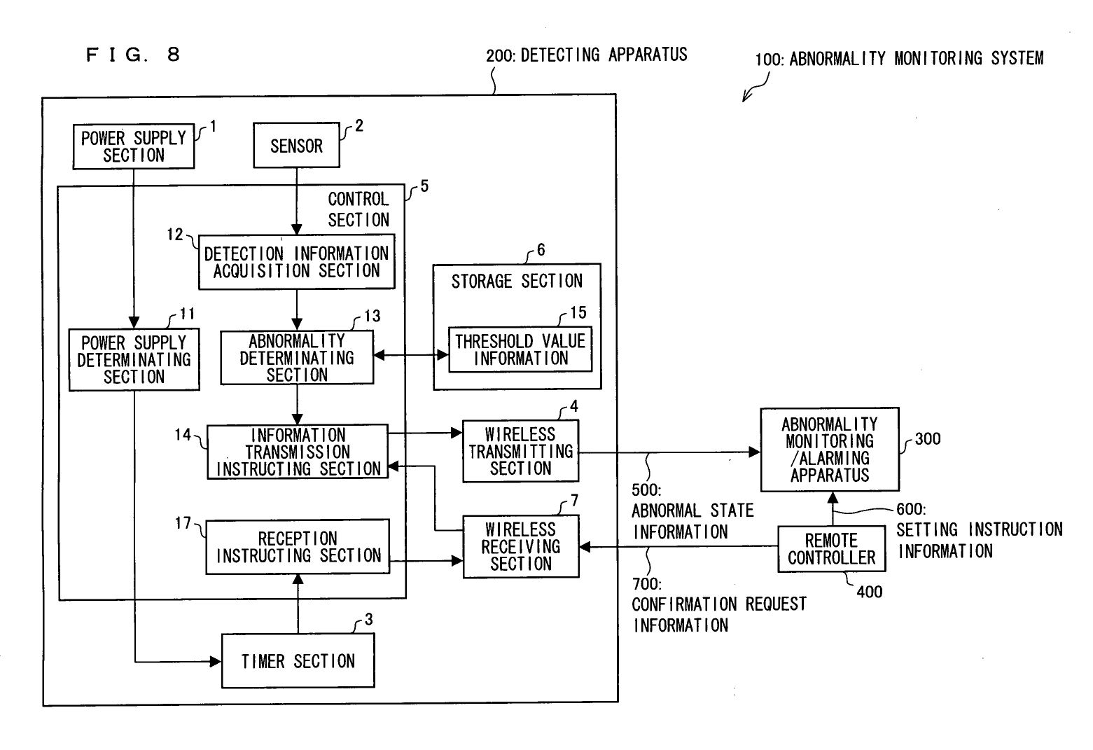

With reference to FIG. 8, the following explains a detecting apparatus 200 according to Embodiment 3, i.e., another embodiment of the present invention. FIG. 8 shows the embodiment of the present invention, and is a block diagram showing an arrangement of a main portion of the detecting apparatus 200 provided in the abnormality monitoring system 100.

The detecting apparatus 200 according to the present embodiment is different from the detecting apparatus 200 according to Embodiment 1 as follows.

That is, in addition to the arrangement of the detecting apparatus 200 shown in FIG. 1, the detecting apparatus 200 according to the present embodiment includes a wireless receiving section 7 for receiving confirmation request information 700 from the remote controller 400. The confirmation request information 700 is information for requesting the detecting apparatus 200 to transmit the abnormal state information 500 as the confirmation information, and is transmitted from the remote controller 400 to the detecting apparatus 200 in response to a user's operation of an operation key (not shown) provided in the remote controller 400.

That is, the wireless receiving section 7 receives the confirmation request information 700 from the remote controller 400, and then transmits the confirmation request information 700 to the information transmission instructing section 14. Then, upon receiving the confirmation request information 700 via the wireless receiving section 7, the information transmission instructing section 14 transmits the abnormal state information 500 as the confirmation information to the abnormality monitoring/alarming apparatus 300 via the wireless transmitting section 4.

Thus, the detecting apparatus 200 of the abnormality monitoring system 100 according to the present embodiment can transmit the abnormal state information 500 as the confirmation information to the abnormality monitoring/alarming apparatus 300 in response to the confirmation request information 700 transmitted from the remote controller 400.

Further, the abnormality monitoring system 100 according to the present embodiment is different from the abnormality monitoring system 100 of Embodiment 1 in that: the timer section 3 measures a predetermined period of time having elapsed since a connecting of a battery to the power supple section 1 was carried out so as to start power supply, and notifies a reception instructing section 17 that the predetermined period of time has elapsed.

Further, the detecting apparatus 200 according to the present embodiment is different from the arrangement of the detecting apparatus 200 shown in FIG. 1 in that: the control section 5 further includes the reception instructing section 17 as a functional block. The reception instructing section 17 receives, from the timer section 3, the notification indicating that the predetermined period of time has elapsed, and then instructs the wireless receiving section 7 to stop maintaining a standby state in which the wireless receiving section 7 can receive transmitted information.

According to the foregoing arrangement, the wireless receiving section 7 maintains the standby state for a preset period of time. This makes it possible to reduce power consumption necessary for maintaining the standby state.

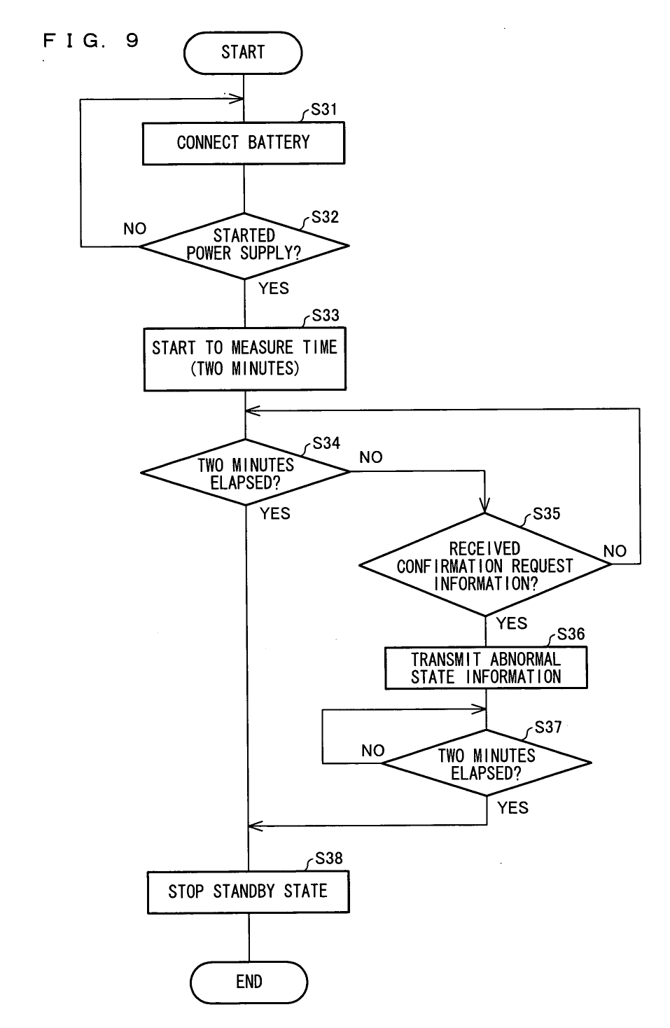

That is, as described below in accordance with a process flow shown in FIG. 9, the detecting apparatus 200 according to the present embodiment can transmit the abnormal state information 500 as the confirmation information in response to the confirmation request information 700 transmitted from the remote controller 400. Note that FIG. 9 is a flow chart illustrating an example of processes which are carried out by the detecting apparatus 200 according to the embodiment and in which the abnormal state information 500 is transmitted as the confirmation information to the abnormality monitoring/alarming apparatus 300.

(Process 2 of Transmitting Abnormal State Information as Confirmation Information)

See FIG. 9. First, when a connecting of battery, acting as the power source, is carried out in the detecting apparatus 200 (S31), the power supply determinating section 11 of the control section 5 determines whether or not the power supply has started (S32). In cases where the power supply determinating section 11 of the control section 5 determines that the power supply has started (“YES” in S32), the power supply determinating section 11 of the control section 5 instructs the timer section 3 to measure time (S33). The timer section 3 is set so as to measure two minutes (S34). The wireless receiving section 7 of the detecting apparatus 200 is in the standby state until the timer section 3 finishes measuring the two minutes, so as to be able to receive the confirmation request information 700 transmitted from the remote controller 400. During the two minutes, the vehicle is in a normal parking state, and the user sets the abnormality monitoring/alarming apparatus 300 to be the alert state by using the remote controller 400.

In cases where the wireless receiving section 7 receives, by the time the timer section 3 finishes measuring two minutes (“NO” in S34), the confirmation request information 700 from the remote controller 400 (“YES” in S35), the wireless receiving section 7 instructs the information transmission instructing section 14 of the control section 5 to transmit the abnormal state information 500 as the confirmation information. In response to the instruction, the information transmission instructing section 14 of the control section 5 instructs the wireless transmitting section 4 to transmit the abnormal state information 500 to the abnormality monitoring/alarming apparatus 300 (S36).

Then, the wireless receiving section 7 maintains the standby state until two minutes elapse (“NO” in S37). When two minutes have elapsed (“YES” in S37), the reception instructing section 17 of the control section 5 instructs the wireless receiving section 7 to exit the standby state (S38).

On the other hand, in cases the wireless receiving section 7 receives no confirmation request information 700 from the remote controller 400 by the time the timer section 3 finishes measuring two minutes (“YES” in S34), the reception instructing section 17 of the control section 5 instructs the wireless receiving section 7 to exit the standby state (S38).

As described above, the detecting apparatus 200 according to the present embodiment can transmit the abnormal state information 500 as the confirmation information to the abnormality monitoring/alarming apparatus 300 in response to the confirmation request information 700 transmitted from the remote controller 400. Further, the detecting apparatus 200 is arranged such that: the wireless receiving section 7 maintains the standby state only for a certain period of time (two minutes) so as to wait to receive the confirmation request information 700 from the remote controller 400. Therefore, the wireless receiving section 7 operates only for a certain period of time. This makes it possible to reduce power consumption.

Further, the foregoing description assumes that the predetermined period of time is two minutes. However, the period of time is not limited to this as long as it is long enough for the user to (i) install the detecting apparatus 200 in the vehicle so that the detecting apparatus 200 is put in an appropriate position, (ii) set the detecting apparatus 200 in the alert state, and (iii) transmit the confirmation request information from the remote controller 400. For example, the period of time may be one minute or may be five minutes.

Further, the wireless receiving section 7 maintains the standby state for the predetermined period of time. However, instruction information for stopping the standby mode of the wireless receiving section 7 may be transmitted from the remote controller 400 once it is confirmed that the abnormal state information 500 can be properly transmitted from the detecting apparatus 200 to the abnormality monitoring/alarming apparatus 300 in response to the confirmation request information 700 transmitted from the remote controller 400. With this arrangement, the standby state of the wireless receiving section 7 can be stopped as soon as it is confirmed whether or not the abnormal state information 500 can be properly transmitted. This makes it possible to further reduce power consumption.

Alternatively, the arrangement in which the wireless receiving section 7 exits the standby state when the predetermined period of time has elapsed may be combined with the arrangement in which the wireless receiving section 7 exits the standby state in response to the instruction given from the remote controller 400.

With this combination, even in cases where the remote controller 400 and the detecting apparatus 200 cannot properly communicate with each other and the instruction for stopping the standby state cannot be therefore given via the remote controller 400, the wireless receiving section 7 can exit the reception state when the predetermined period of time has elapsed.

Further, although the detecting apparatus 200 according to the present embodiment is arranged such that the abnormal state information 500 is transmitted as the confirmation information to the abnormality monitoring/alarming apparatus 300, the confirmation information may be different from the abnormal state information 500. That is, the information transmitted to the abnormality monitoring/alarming apparatus 300 in cases where occurrence of an abnormal state is determined by the abnormality determinating section 13 in accordance with the result of the detection carried out by the sensor 2 may be different from the information that is transmitted to the abnormality monitoring/alarming apparatus 300 in cases where the information transmission instructing section 14 receives the confirmation request information 700 transmitted from the remote controller 400.

However, in the case where the detecting apparatus 200 is arranged so as to transmit the abnormal state information 500 and the confirmation information that are different from each other, the abnormality monitoring/alarming apparatus 300 needs to be provided with means for determining whether the information transmitted from the detecting apparatus 200 is the abnormal state information 500 or the confirmation information. Therefore, for the purpose of simplification of processes carried out in the abnormality monitoring/alarming apparatus 300, it is preferable that the abnormal state information 500 be transmitted, as both the abnormal state information 500 and the confirmation information, to the abnormality monitoring/alarming apparatus 300.

Further, the abnormality monitoring/alarming apparatus 300 shown in each of Embodiments 1 to 3 is arranged so as to carry out the intimidating operation (of sounding a buzzer) in accordance with the abnormal state information 500 transmitted from the detecting apparatus 200. However, the present invention is not limited to this.

For example, the abnormality monitoring/alarming apparatus 300 may include a display section (not shown) for displaying a content of the abnormal state information 500 transmitted from the detecting apparatus 200. Alternatively, the abnormality monitoring/alarming apparatus 300 may notify another apparatus of the occurrence of the abnormality upon receiving the abnormal state information 500.

That is, the abnormality monitoring/alarming apparatus 300 only needs to be an information processing apparatus that (i) receives abnormal state information indicating an abnormality state detected by the detecting apparatus 200 and (ii) carries out a process in accordance with the abnormal state information.

Further, the intimidating operation may include not only the sounding of a buzzer but also intimidation using a light of a flashlight or the like.

Operating means such as a CPU executes a program stored in storage means such as a ROM (read only memory) and a RAM (random access memory) so as to control input means (e.g., a keyboard), output means (e.g., a display), or communication means (e.g., an interface circuit). In this way, the members (especially the power supply determinating section 11, detection information acquisition section 12, abnormality determinating section 13, information transmission instructing section 14, and reception instructing section 17 of the detecting apparatus 200 and the alert state determinating section 40, information acquisition section 41, and alert instructing section 42 of the abnormality monitoring apparatuses 300) and processes of the detecting apparatuses 200 and abnormality monitoring apparatuses 300 respectively shown in Embodiments 1 to 3 are achieved and executed.

Therefore, the foregoing various functions and processes of the detecting apparatus 200 of the present embodiment can be achieved by simply causing a computer having these means to read and execute the program stored in a storage medium. Further, by storing the program in a removable storage medium, the various functions and processes can be achieved on any computer.

Such a computer program storage medium may be a memory (not shown), such as a ROM, so that the process is executable on a microcomputer. Alternatively, a program medium may be used which can be read by inserting the storage medium in an external storage device (program reader device; not shown).

In addition, in either of the cases, it is preferable if the contained program is accessible to a microprocessor which will execute the program. Further, it is preferable if the program is read, and the program is then downloaded to a program storage area of a microcomputer where the program is executed. Assume that the program for download is stored in a main body device in advance.

In addition, the program medium is a storage medium arranged so that it can be separated from the main body. Examples of such a program medium include a tape, such as a magnetic tape and a cassette tape; a magnetic disk, such as a flexible disk and a hard disk; a disc, such as a CD/MO/MD/DVD; a card, such as an IC card (inclusive of a memory card); and a semiconductor memory, such as a mask ROM, an EPROM (erasable programmable read only memory), an EEPROM (electrically erasable programmable read only memory), or a flash ROM. All these storage media hold a program in a fixed manner.

Alternatively, if a system can be constructed which can connects to the Internet or other communications network, it is preferable if the program medium is a storage medium carrying the program in a flowing manner as in the downloading of a program over the communications network.

Further, when the program is downloaded over a communications network in this manner, it is preferable if the program for download is stored in a main body device in advance or installed from another storage medium.

The present invention is not limited to the description of the embodiments above, but may be altered by a skilled person within the scope of the claims. An embodiment based on a proper combination of technical means disclosed in different embodiments is encompassed in the technical scope of the present invention.

The detecting apparatus according to the present invention is preferably arranged so as to further include: timer means for (i) measuring time for the predetermined period of time and (ii) notifying the transmitting means of time information indicating that the predetermined period of time has elapsed, wherein: the transmitting means transmits the confirmation information to the information processing apparatus in accordance with the time information notified by the timer means.

According to the foregoing arrangement, the detecting apparatus according to the present invention includes the timer means, and therefore makes it possible to know that the predetermined period of time has elapsed. This allows the detecting apparatus according to the present invention to transmit the confirmation information to the information processing apparatus after the predetermined period of time has elapsed. Therefore, the detecting apparatus makes it possible to confirm whether or not information indicating a detection result can be properly transmitted to a destination.

Further, the detecting apparatus does not need to receive an instruction for transmitting any confirmation information, and therefore does not need to maintain a standby state in preparation for the reception. Therefore, the detecting apparatus allows reduction of power consumption therein.

Further, in the foregoing arrangement, the detecting apparatus according to the present invention is preferably arranged such that: the timer means notifies the time information after the predetermined period of time has elapsed since a start of power supply to the detecting apparatus.

Thus, the time information is notified after the predetermined period of time has elapsed since the start of the power supply. Therefore, while using the detecting apparatus, the detecting apparatus can confirm whether or not the detection result can be properly transmitted to the destination.

In the foregoing arrangement, the detecting apparatus according to the present invention may be arranged so as to further include: detecting means for detecting a state of the monitored object; and determining means for determining, in accordance with a detection result of detection carried out by the detecting means, whether or not the detection result indicates the predetermined condition, wherein: the transmitting means transmits the confirmation information to the information processing apparatus when the determining means determines that the detection result of the detection carried out by the detecting means indicates the predetermined condition.

According to the foregoing arrangement, the detecting apparatus includes the detecting means, and therefore can detect the state of the monitored object. Further, the detecting apparatus includes the determining means, and therefore can determine whether or not the detection result of the detection carried out by the detecting means indicates the predetermined condition. Further, in cases where the determining means determines that the detection result of the detection carried out by the detecting means indicates the predetermined condition, the transmitting means can transmit the confirmation information to the information processing apparatus. That is, the detecting apparatus according to the present invention can transmit the confirmation information to the information processing apparatus in accordance with the result of the detection carried out by the detecting means.

Further, the detecting apparatus can be given the predetermined condition, such as vibration or sound, which can be detected by the detecting means of the detecting apparatus.

This makes it unnecessary for the detecting apparatus to include receiving means for receiving, from another apparatus or the like, the instruction for transmitting the confirmation information. Therefore, the detecting apparatus does not need to maintain the standby state in preparation for the reception.

That is, the detecting apparatus does not need to maintain the reception standby state, and therefore allows reduction of power consumption therein.

Therefore, the detecting apparatus according to the present invention allows an effect of (i) reducing the power consumption of the detecting apparatus and (ii) confirming whether or not the information indicating the detection result can be properly transmitted to the destination.

Further, in the foregoing arrangement, the detecting apparatus according to the present invention may be arranged so as to further include: receiving means for receiving, as the predetermined condition, instruction information for transmitting the confirmation information; and timer means for (i) measuring a predetermined period of time and (ii) notifying the receiving means of time information indicating that the predetermined period of time has elapsed, wherein: in accordance with the time information notified by the timer means, the receiving means exits a reception standby state in which the receiving means is capable of receiving information from outside.

The detecting apparatus includes the receiving means, and therefore can receive the instruction information. This allows the detecting apparatus to transmit the confirmation information to the information processing apparatus in accordance with the instruction information. Therefore, the detecting apparatus makes it possible to confirm whether or not the information indicating the detection result can be properly transmitted to the destination.

Further, the receiving means can exit the reception standby state in accordance with the time information notified by the timer means. This makes it possible to reduce power consumption necessary for maintaining the reception standby state.

Therefore, the detecting apparatus makes it possible to (i) confirm whether or not the information indicating the detection result can be properly transmitted, and (ii) reduce an amount of power to be consumed by the detecting apparatus.

Further, in the foregoing arrangement, the detecting apparatus according to the present invention may be arranged such that: the monitored object is a vehicle, the detecting apparatus being provided in the vehicle so as to be put in a predetermined position.

The detecting apparatus makes it possible to (i) reduce the amount of power to be consumed by the detecting apparatus, and (ii) confirm whether or not the information indicating the detection result can be properly transmitted to the information processing apparatus. This allows the user to install the detecting apparatus in the vehicle, i.e., the monitored object so that the detecting apparatus is put in such a position that it is difficult to directly operate the detecting apparatus.

Further, in order to solve the foregoing problems, an abnormality monitoring system according to the present invention includes: the foregoing detecting apparatus; and an information processing apparatus for carrying out a process in accordance with abnormal state information transmitted by the detecting apparatus.

According to the foregoing arrangement, in the abnormality monitoring system, the detecting apparatus can transmit confirmation information to the information processing apparatus in accordance with a predetermined condition. Therefore, the detecting apparatus makes it possible to confirm whether or not the detected abnormal state information can be properly transmitted to the information processing apparatus.

Further, in the abnormality monitoring system according to the present invention, the detecting apparatus does not need to include receiving means for receiving, from another apparatus or the like, an instruction for transmitting the confirmation information, and therefore does not need to maintain a standby state in preparation for the reception. That is, the detecting apparatus does not need to maintain the reception standby state, and therefore makes it possible to reduce power consumption of the detecting apparatus.

Therefore, the abnormality monitoring system according to the present invention brings about an effect of (i) reducing the power consumption of the detecting apparatus and (ii) confirming whether or not the information indicating the detection result can be properly transmitted to the destination, i.e., the information processing apparatus.

Further, in the foregoing arrangement, the abnormality monitoring system according to the present invention is preferably arranged such that: the detecting apparatus and the information processing apparatus are connected to each other wirelessly.

In the foregoing abnormality monitoring system, the detecting apparatus and the information processing apparatus are connected to each other wirelessly. This makes it unnecessary to provide a wire for connecting the detecting apparatus and the information processing apparatus to each other.

This makes it possible to easily install the detecting apparatus in an appropriate place.

Further, in the foregoing arrangement, the abnormality monitoring system is preferably arranged such that: the detecting apparatus and the information processing apparatus are provided in a vehicle so as to be put in a predetermined position.

Note that each of the means of the detecting apparatus may be realized with the use of a computer. In this case, a computer-readable recording medium storing a detecting apparatus control program realizing the detecting apparatus with the use of a computer by operating the computer as each of the means is also encompassed in the scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A detecting apparatus according to the present invention is a detecting apparatus for (i) detecting an abnormal state of a monitored object and (ii) transmitting, to an information processing apparatus for carrying out a process in accordance with the abnormal state information, abnormal state information indicating the abnormal state, the detecting apparatus, including: transmitting means for transmitting confirmation information to the information processing apparatus in accordance with a predetermined condition, which confirmation information is information for confirming establishment of communication between the detecting apparatus and the information processing apparatus. This allows the detecting apparatus to (i) transmit the confirmation information in accordance with the predetermined condition and (ii) confirm whether or not a detection result of the detection carried out by the detecting apparatus can be properly transmitted to the information processing apparatus. Further, the detecting apparatus can reduce its own power consumption. Therefore, the detecting apparatus can be installed in the monitored object so as to be put in a place where an abnormal state need to be detected, and can be widely used for monitoring whether or not an abnormal state has occurred in the monitored object.

1. A detecting apparatus for (i) detecting an abnormal state of a monitored object and (ii) transmitting, to an information processing apparatus, abnormal state information indicating the abnormal state, which information processing apparatus carries out a process in accordance with the abnormal state information,
the detecting apparatus, comprising:
transmitting means for transmitting confirmation information to the information processing apparatus in accordance with a predetermined condition, which confirmation information is information for confirming establishment of communication between the detecting apparatus and the information processing apparatus.

2. The detecting apparatus as set forth in claim 1, wherein:
the predetermined condition is information indicating that a predetermined period of time has elapsed; and
the transmitting means transmits the confirmation information to the information processing apparatus after the predetermined period of time has elapsed.

3. The detecting apparatus as set forth in claim 2, further comprising:
timer means for (i) measuring the predetermined period of time and (ii) notifying the transmitting means of time information indicating that the predetermined period of time has elapsed,
wherein:
the transmitting means transmits the confirmation information to the information processing apparatus in accordance with the time information notified by the timer means.

4. The detecting apparatus as set forth in claim 3, wherein:
the timer means notifies the time information after the predetermined period of time has elapsed since a start of power supply to the detecting apparatus.

5. The detecting apparatus as set forth in claim 1, further comprising:
detecting means for detecting a state of the monitored object; and
determining means for determining, in accordance with a detection result of detection carried out by the detecting means, whether or not the detection result indicates the predetermined condition,
wherein:
the transmitting means transmits the confirmation information to the information processing apparatus when the determining means determines that the detection result of the detection carried out by the detecting means indicates the predetermined condition.

6. The detecting apparatus as set forth in claim 1, further comprising:
receiving means for receiving, as the predetermined condition, instruction information for transmitting the confirmation information; and
timer means for (i) measuring a predetermined period of time and (ii) notifying the receiving means of time information indicating that the predetermined period of time has elapsed,
wherein:
in accordance with the time information notified by the timer means, the receiving means exits a reception standby state in which the receiving means is capable of receiving information from outside.

7. The detecting apparatus as set forth in claim 1, wherein:
the monitored object is a vehicle, the detecting apparatus being installed in the vehicle.

8. An abnormality monitoring system, comprising:
the detecting apparatus as set forth in claim 1; and
an information processing apparatus for carrying out a process in accordance with abnormal state information transmitted by the detecting apparatus.

9. The abnormality monitoring system as set forth in claim 8, wherein:
the detecting apparatus and the information processing apparatus are connected to each other wirelessly.

10. The abnormality monitoring system as set forth in claim 8, wherein:
the detecting apparatus and the information processing apparatus are installed in a vehicle.

11. (canceled)

12. (canceled)

13. The detecting apparatus as set forth in claim 5, wherein:
the detecting means is a vibration sensor for detecting a vibration; and
when the detecting means detects a predetermined number of continuous vibrations each not more than a threshold value, the determining means determines that the detection result indicates the predetermined condition.

14. The detecting apparatus as set forth in claim 5, wherein:
the detecting means is an acoustic sensor or a sound pressure sensor; and
when the detecting means detects a predetermined number of continuous sounds each not more than a threshold value, the determining means determines that the detection result indicates the predetermined condition.
